(19) United States
(12) Patent Application Publication
(10) Pub. No.: US 2019/0321968 A1
(43) Pub. Date: Oct. 24, 2019

(54) MOTOR-DRIVE ASSEMBLY CAPABLE OF DEPLOYING A TRACTION FORCE, USE OF THE ASSEMBLY FOR THE MOTORIZED DRIVING OF AN ARTICULATED ARM, AND ASSOCIATED METHOD

(71) Applicant: PUSH4M, Paris (FR)

(72) Inventor: Nicolas DE LUSSY, Boulogne-Billancourt (FR)

(73) Assignee: PUSH4M, Paris (FR)

(21) Appl. No.: 16/470,601

(22) PCT Filed: Dec. 21, 2017
(86) PCT No.: PCT/FR2017/053789

§ 371 Date: Jun. 18, 2019

(30) Foreign Application Priority Data
Dec. 28, 2016 (FR) 1663448

(51) Int. Cl. B25J 9/10; B25J 9/16; B25J 11/00

(52) U.S. Cl. CPC B25J 9/104; E02F 3/46; B25J 11/005; B25J 9/162

(57) ABSTRACT

The invention relates to an articulated arm having a first member connected to a second member by a hinge pivoting about an axis, said articulated arm being motor-driven by a motor-drive assembly comprising: —at least one first motor devices and one second motor device; —at least one inextensible tension belt connecting the first and second members; —each motor device having at least two pushing means configured to exert a transverse push on the tension belt; and —a control member capable of operating the pushing means according to a sequence that includes at least the application of a transverse pushing force to the tension belt leading to a deformation and an increase in the tension of said belt, supported by the first motor device, and at least the application of a transverse pushing force producing a deformation and an increase in the tension of the inextensible belt supported by the second motor device; the deformations accompanied by successive increases in tension allow the second member to pivot about the hinge axis.

### FIELD OF THE INVENTION

The field of the invention is that of motor-drive systems for arms of site machinery, for handling machinery, for industrial articulated arms, and for robot arms.

The invention also finds applications in any other field necessitating the movement of a lever arm or the application of a traction force, for example in the civil engineering field or in the field of force assistance exoskeletons and in the field of prostheses and ortheses.

### PRIOR ART

There exist numerous systems enabling traction by a cable, for example for lifting a load by means of a pulley. To apply traction to an object it is necessary at present to employ a motor-drive system between the point of resistance and the object to be moved. Those systems come in multiple forms but their functioning most often relies either on a longitudinal cylinder system or on the use of a rotary motor.

Using a longitudinal cylinder to lift a load has the disadvantage that power can effectively be furnished only over a restricted lifting distance.

Using a rotary motor to lift a load has the disadvantage of providing a torque of limited power.

Also, the prior art knows the use of a flexible cylinder that is shortened by combining a multidirectional expansion balloon with a net of inextensible fibers with lozenge-shape meshes. In this type of system the pressure applied to increase the pressure in the balloon drives the shortening of the cylinder. The use of this principle for direct lifting of a load has the disadvantage of being able to lift a load over only a restricted lifting distance.

In the above three cases, for moving a load, the work of the motors must supply a sufficient force to support the weight of the load and to accelerate it.

A system enabling traction on a cable can be adapted to the motorization of a lever arm for moving an articulated arm by fixing the cable to two separate members articulated to one another. These types of lever arms most often belong to the class of inter-motor levers that have the disadvantage of necessitating the use of a force torque greater than the resisting torque to mobilize the pivoting lever from the base of the mechanical system. In this case using the aforementioned three types of systems has limitations.

Using a longitudinal cylinder on a third class lever arm has the disadvantage that the power can be furnished effectively over only a restricted angle of rotation.

Using a rotary motor on a third class lever arm has the disadvantage of furnishing a torque of limited power.

Using a flexible cylinder the shortening of which is produced by combining a multidirectional expansion balloon with a net of inextensible fibers with lozenge-shape meshes may be employed for lifting a load by means of an articulated arm. In fact, on increasing the internal pressure the lozenge is deformed as a result of shortening its length which produces a longitudinal traction force, and is subject to a transverse compressive reaction force that is a multiple of the applied force. Consequently, the flexible cylinder causes a non-linear movement, very fast on starting up and slow at the end, and the power of the cylinder decreases as it takes on volume.

An object of the invention is to remedy at least in part the aforementioned limitations of the prior art by offering mobilization of the lever by at least one hundred and thirty degrees of rotation from the pivot and requiring a low expenditure of energy whatever the position of the base carrying the lever arm.

### STATEMENT OF INVENTION

One particularly advantageous implementation of the invention concerns the lifting of a load by a lever arm. In a first aspect, the invention therefore concerns an articulated arm including a first member connected by an articulation pivoting about an axis to a second member, and the articulated arm is motorized by a motor-drive assembly including:
at least one first motor-drive device and one second motor-drive device,
at least one inextensible traction belt connecting the first and second members,
each motor-drive device including at least two pushing means configured to exert a transverse thrust on the traction belt, and
a control member adapted to cause the pushing means to function in a sequence including at least the application of a transverse thrust force to the traction belt causing deformation of and an increase in the tension in said belt, carried by the first motor-drive device, and at least the application of a transverse thrust force causing deformation of and an increase in the tension in the inextensible belt carried by the second motor-drive device, the successive deformations and increases in tension enabling pivoting of the second member about the axis of the articulation.

Thus by causing two motor-drive devices to cooperate, the invention proposes a motor-drive system which is relieved of taking up the load by virtue of its internal strength and has to provide only positive acceleration of the load.

The invention also enables stopping of the movement at will, modification of the load without feedback reaction and passive return of the system with no load.

In embodiments, at least one motor-drive device employs a so-called force pushing means that includes a cylinder configured to exert a transverse force on a narrow portion of the inextensible traction belt so that the angle between the traction belts at rest and the traction belt moved by the so-called force pushing means is able at least to vary from zero to fifteen degrees.

Thanks to these features, the force imposed by the so-called force pushing means on the inextensible traction belt is applied optimally to enable the pivoting of a lever arm.

In embodiments, at least one motor-drive device employs a so-called amplitude pushing means that includes a plurality of cylinders configured to exert a transverse thrust over a larger extent of the inextensible traction belt.

Thanks to these features, the force imposed by the so-called amplitude pushing means on the inextensible traction belt is applied optimally to enable deformation of the belt in order to maintain the inextensible traction belt under tension after pivoting of the lever arm. Hereinafter the expansion of the belt during pivoting of the lever arm will be termed the “amplitude gain”.

By coupling two pushing means, one termed force and the other termed amplitude, the invention solves a problem connected to the conversion of transverse force energy into longitudinal force energy.

In embodiments, the attachment point of the second member is positioned at a distance from the articulation less than 20% of the length of the second member.

This kind of placement of the attachment point, which is advantageous in some situations, is permitted by the articulated arm according to the invention whereas it is possible in prior art solutions only at the cost of highly unsatisfactory performance.

In embodiments, at least one motor-drive device includes a tensioner system configured to tension the traction belt by bearing on a pushing means.

Thanks to these features, the traction belt can be stiffened on a pushing means, in particular on the so-called amplitude pushing means, which optimizes the energy consumption of the mechanical assembly for the conservation of the amplitude gain.

In embodiments, the tensioning system includes at least one belt connected to the traction belt via two sliding attachments.

Thanks to these features, the tensioning system enables tensioning of the traction belt to avoid having to oversize the so-called amplitude pushing means.

In embodiments, at least one motor-drive device includes at least one pulley or at least one metal bar arranged so as to bend the traction belt on itself in a “U” shape over a portion of its length.

Thanks to these features, the overall size of the motor-drive device is greatly reduced.

In embodiments, the transverse thrust exerted by the at least one of the pushing means is exerted by one or more cylinders, the thrust of the cylinders being exerted on a belt, and the greater the number of cylinders the larger the bearing area. The pressure to be injected to obtain the required thrust is therefore lower. This applies in particular to the so-called amplitude pushing means.

In embodiments, the transverse thrust exerted by the at least one of the pushing means is produced by means of one or more hydraulic cylinders.

In embodiments, a cylinder includes locking means of rack, abutment, brake, or valve type.

Thanks to these features, the cylinders are locked at a required extended position of the piston, for example to maintain the traction belt under tension without additional expenditure of energy.

In embodiments, the articulated arm according to the invention includes a supplementary motor-drive assembly enabling pivoting of the second member about the axis in the opposite rotation direction.

Thanks to these features, the articulated arm can be moved about a rotation axis in either direction in the same plane without assistance from the force of gravity.

In embodiments, the first member and the second member are articulated by a ball-joint connection and the articulated arm includes at least three motor-drive assemblies disposed in a triangle all around the first member, enabling pivoting of the second member in all directions.

Thanks to these features, the articulated arm can be moved in all directions.

In a second aspect, the invention concerns a multi-articulated arm that includes a plurality of articulated arms according to the invention, said articulated arms being interconnected in series.

In embodiments, the inextensible traction belt of at least one motor-drive device is fastened to the inextensible traction belt of the motor-drive device of the next articulated arm by a common point of contact.

Thanks to these features, the belt traction actuated by a motor-drive assembly according to the invention is multiplied serially in order to produce controlled movement of the load at the end of the traction belt, or of a cable carrying a load positioned at the end of the last member, with a lower expenditure of energy.

In a third aspect, the invention concerns a method of lifting a load by means of an articulated arm including a first member articulated to a second member and by a motor-drive assembly controlled by a control member and including a first motor-drive device and a second motor-drive device, said lifting method including the following steps:
traction on a first inextensible traction belt connecting an attachment point on the first member to an attachment point on the second member, and
traction on a second inextensible traction belt connecting an attachment point on the first member to an attachment point on the second member,

at least one of the traction steps employing a transverse thrust on a traction belt and the traction steps being repeated until the second member is raised to a required height.

According to the method according to the invention, a first motor-drive device connected to a first traction belt and a second motor-drive device connected to a second traction belt advantageously cooperate to exert a traction force with the aim of lifting a load or of moving a lever arm. The two motor-drive devices function in sequence. The example given hereinafter considers the amplitude of deployment of an articulated arm.

For example, considering a state of the motor-drive assembly in which the traction belts of a first motor-drive device and a second motor-drive device are in tension:
application of a transverse force to the first belt by the so-called force pushing means of the first motor-drive device enables an amplitude gain and therefore expansion of the second belt,
the tension on the second belt is produced by the application of a transverse force by the so-called amplitude pushing means to the second motor-drive device.

The tension in the inextensible belt of the second motor-drive device is balanced by reducing the pressure in its tensioning system. Once amplitude and forces have been balanced, the position is imposed by the two systems interchangeably.

Afterwards, starting the so-called force pushing means of the second motor at low pressure could produce the traction force bringing about expansion of the inextensible belt of the first motor-drive device to enable reinitialization of the so-called force pushing means and of the tensioning system.

Thanks to these features, the so-called amplitude transverse pushing system may be actuated at low pressure to take up the successive amplitude gains.

Thanks to these features, the so-called force transverse pushing system can be actuated at low pressure to impose a maximum force on the inextensible belt to produce the power of the motor torque.

Thanks to these features, the tensioning system can be actuated at low pressure to impose balancing of tension between the two inextensible belts of the two motors coupled to produce the transfer of load between the two motors with no loss of force or amplitude.

Thanks to these features, this transfer of load between two motors enables optimization of the expenditures of energy.

In embodiments, the method according to the invention further includes tensioning by a tensioning system of the traction belt bearing on a pushing means.

In embodiments, at least one traction step includes, in sequence, the following steps:
releasing the tension exerted on the traction belt by a so-called force pushing means and releasing the tension exerted by the tensioning system,
tensioning the traction belt by transverse thrust from a so-called amplitude pushing means,
tensioning the traction belt bearing on a pushing means by a tensioning system,
tensioning the traction belt by transverse thrust from a so-called force pushing means, and
monitoring the lifting of the second member.

In embodiments, the method according to the invention further includes an initialization step including the following steps:
tensioning by the so-called amplitude pushing means of the first motor-drive device and the second motor-drive device,
monitoring the lifting of the second member, and
tensioning the traction belt of the second motor-drive device by transverse thrust from a so-called force pushing means.

In a fourth aspect, the invention concerns mobile site machinery that includes at least one articulated arm according to the invention.

Other advantages, aims and features of the lifting method according to the invention being the same as those of the articulated arm according to the invention, they are not repeated here.

In a third aspect, the invention concerns a load traction system including:
at least two motor-drive devices,
each motor-drive device being mounted on the first member and including an inextensible traction belt connecting an attachment point on the first member to an attachment point on the second member,
each motor-drive device including at least two pushing means configured to exert a transverse thrust on the traction belt, and
a control unit adapted to cause the pushing means of the motor-drive devices to function in a predetermined sequence, the tension exerted on the belts enabling movement of the load.

### DESCRIPTION OF THE FIGURES

The invention will be better understood on reading the following description given by way of nonlimiting example and with reference to the figures, in which:

FIG. 1 is a diagrammatic front three-quarter perspective view of a particular first embodiment of a motor-drive device of an articulated arm according to the invention,

FIG. 2 is a diagrammatic three-quarter rear perspective view of the motor-drive device from FIG. 1,

FIG. 3 is a diagrammatic three-quarter perspective view of a first embodiment of a motor-drive assembly including two motor-drive devices,

FIG. 4 is a diagrammatic perspective view of a particular first embodiment of an articulated arm according to the invention that includes two motor-drive assemblies,

FIG. 5 is a diagrammatic side view of a particular first embodiment of an articulated arm according to the invention,

FIG. 6 represents in the form of a flowchart a particular method of using an articulated arm according to the invention,

FIG. 7 is a diagrammatic three-quarter front perspective view of a particular second embodiment of an articulated arm according to the invention,

FIG. 8 is a diagrammatic three-quarter rear perspective view, by transparency, of a particular second embodiment of an articulated arm according to the invention,

FIG. 9 is a diagrammatic front view of a second particular embodiment of an articulated arm according to the invention,

FIG. 10 shows diagrammatically in section taken along the line A-A a second particular embodiment of an articulated arm according to the invention,

FIG. 11 is a diagrammatic front view of a second particular embodiment of an articulated arm according to the invention,

FIG. 12 is a diagrammatic view in longitudinal section taken along the line B-B of a second particular embodiment of an articulated arm according to the invention,

FIGS. 13 and 14 are diagrammatic perspective views of a set of articulated arms mounted in series forming a multi-articulated arm,

FIG. 15 is a diagrammatic side view of one particular embodiment of site machinery carrying an articulated arm according to the invention,

FIGS. 16 to 20 are diagrammatic representations of a second particular embodiment of site machinery carrying an articulated arm according to the invention, and

FIGS. 21 to 25 are diagrammatic representations of a particular embodiment of an articulated arm according to the invention in which the pushing means of the articulated arm according to the invention are common to two antagonistic motor-drive assemblies.

### DESCRIPTION OF A FIRST EMBODIMENT OF THE INVENTION

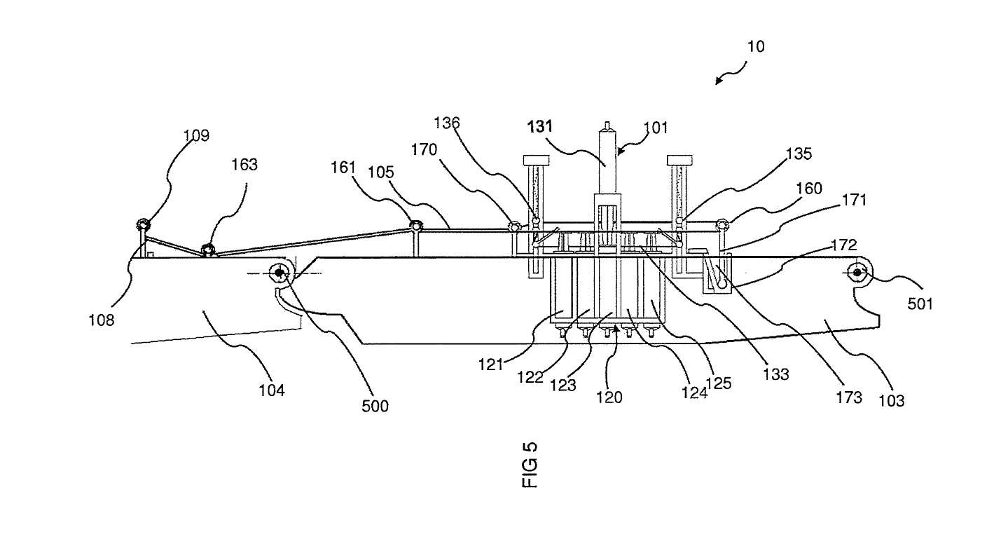

There is seen in FIG. 5 an articulated arm 10 including a first member 103 connected by an articulation pivoting about an axis 500 to a second member 104. The articulated arm 10 is driven by a motor-drive assembly including two motor-drive devices. Said motor-drive devices are mounted on the first member 103 and each includes an inextensible traction belt connecting the first member 103 to the second member 104, and the tension exerted on the inextensible belts enables the second member to pivot about the axis 500.

The articulated arm 10 further includes a control member (not shown) adapted to cause the motor-drive devices to function in accordance with a predetermined sequence.

It is useful to note at this stage that the description of the motor-drive device 101 may also describe other motor-drive devices carried by the articulated arm 10, either directly or via a homothetic, for example axial symmetry or central symmetry, relationship.

The motor-drive device 101 includes an inextensible traction belt 105 connecting an attachment point 108 to an attachment point 109. The belt 105 is a strong flexible strip similar to a transmission belt.

In other embodiments the belt may be a cable, a wire, a chain or any other similar known element.

The traction belt 105 is fixed to the attachment point 108. The belt passes through a passage on the support 163 carried by the second member 104 and a passage on the support 161 carried by the first member 103.

The passages of the supports 161 and 163 may either consist of a simple through-hole the internal surface of which has a low coefficient of friction with the belt 105 or include a ball bearing.

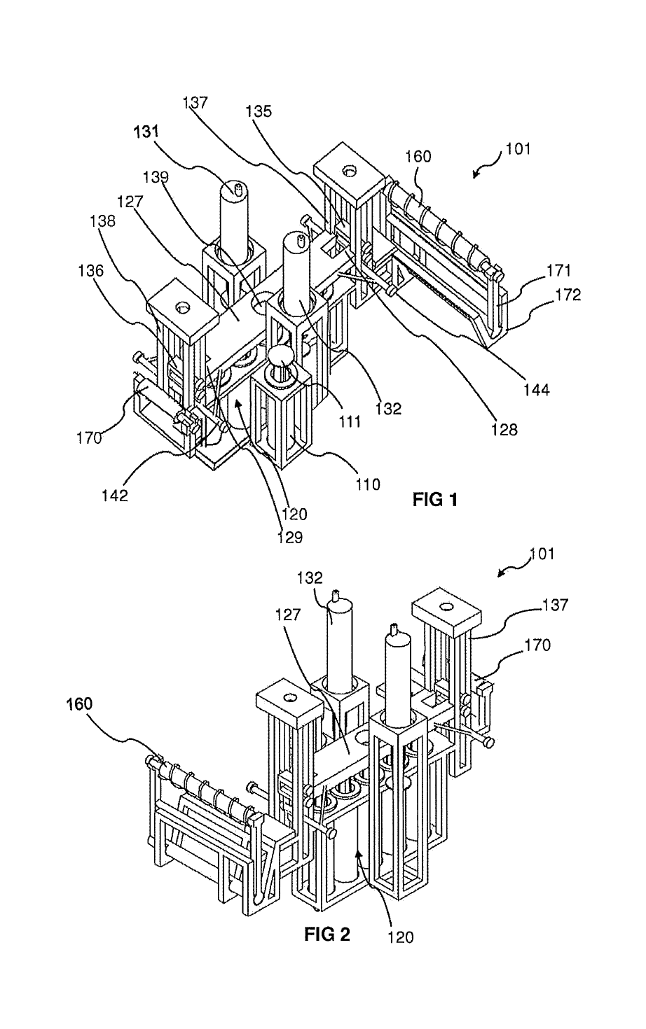

The traction belt 105 continues its run as far as the pulley 160. The length of belt extending from the passage of the support 161 to the pulley 160 forms a first segment. A narrow portion of said first belt segment rests on the piston 111 (see FIG. 1) of a so-called force pushing means 110. The belt 105 is spiral wound several times around the pulley 160 so that the belt 105 is shifted along the pulley on each turn. The belt then continues its run, in a second segment that is offset from and parallel to the first as far as the pulley 170. Over a part of its length the belt is therefore disposed in the shape of a “U”. Between the pulley 160 and the pulley 170 the belt passes into two passages formed by two openings produced in the two sliders 135 and 136. A wide portion of the second belt segment rests on a so-called amplitude pushing means 120. The belt 105 then continues its run so as to pass through a second passage carried by the support 161 and then a second passage carried by the support 163, and the end of the belt 105 is finally fixed to the attachment point 109.

In embodiments (not shown), the belt 105 is shortened and its run finishes at a fixing point on the support 161.

The pulley 160 is advantageously mounted on a pivoting arm 171 itself mounted by means of a pivot connection in a base 172 of “V” shape. At least one spring (not shown) connects each branch of the “V” of the base 172 to the pivoting arm 171 so that, with no tension in the belt 105, the pivoting arm 171 occupies a rest position determined by the stiffness of said springs. The rest position of the pivoting arm 171 is preferably one abutted on or flush with an oblique surface 173 of the “V” shape base 172.

It is useful at this stage to specify that, in order to facilitate an understanding of the drawings, the traction belts and the belts of the tensioning system are not shown in FIGS. 1 to 4.

There is seen in FIGS. 1 and 2 a particular embodiment of a motor-drive assembly 101 of an articulated arm according to the invention. The motor-drive device 101 includes two pushing means 110 and 120 configured to exert a transverse thrust on the traction belt. The motor-drive device 101 further includes a tensioning system.

The so-called force pushing means 110 includes a single cylinder configured to exert an upwardly oriented transverse force on a narrow portion of the belt 105. The belt being arranged so that the angle between the belt at rest and the belt when moved by extending the so-called force pushing means can run from at least zero to at least fifteen degrees.

The so-called amplitude pushing means 120 includes five cylinders 121, 122, 123, 124, 125 disposed in a line. On being deployed, the piston of each of these five cylinders bears on a block 127 of substantially rectangular shape on which the belt 105 rests. The block 127 includes at its two ends 128 and 129 one or more projections that cooperate with a rail formed in the sliders 137 and 138 to enable sliding. The block 127 therefore has only one degree of freedom, in vertical movement in translation. The so-called amplitude pushing means 120 is configured to exert a force by deploying the cylinders 121, 122, 123, 124 and 125. The upwardly oriented force transmitted by the block 127 deforms the belt 105 into a trapezium shape loaded at its two ends by the pulley 160 and the pulley 170. The deformation of the traction belt 105 is effected so as to retain a wide central zone, corresponding to the length of the block 127, parallel to the longitudinal axis of the traction belt 105 at rest.

The tensioning system includes two cylinders 131 and 132, two belts, two sliders 135 and 136 and two slideways 137 and 138. The sliders 135 and 136 bear on the upper face of the traction belt 105. The two sliders 135 and 136 are mounted to slide in the slideways 137 and 138 respectively. Each end 129, 128 of the block 127 includes a respective extension 142, 144 of trapezium shape the base of which is mounted in the slideways 138 and 137, respectively, and extends outward orthogonally to the block 127.

The extension 142 is mounted to slide in the slideway 138. In an equivalent symmetrical manner, the extension 144 is mounted to slide in the slideway 137.

The extensions 142 and 144 form projections in the form of rods on one side of the block 127 (see FIG. 5). A narrow portion of the upper surface of the belt 133 is in contact with the piston of the cylinder 131. The cylinder 131 is configured to exert a downwardly directed force oriented perpendicularly to the belt 133.

In a symmetrical manner, on the other side of the block 127 the extensions 142 and 144 form projections in the form of rods. A narrow portion of said belt connects the sliders, being reflected onto the rods 142 and 144, and its upper surface is in contact with the piston of the cylinder 132. The cylinder 132 is configured to exert a downwardly directed force oriented perpendicularly to the belt of the tensioning system (not shown).

By deploying the cylinders 131 and 132 the tensioning system applies a downwardly oriented force transmitted to the traction belt 105 by way of the sliders 135 and 136. The force applied by the tensioning system contributes to the stiffness of the belt 105 at lower energy cost.

The pressing forces applied by the cylinders 131 and 132 are advantageously similar.

In embodiments, an extension of the piston 123 through the opening 139 assist that system by a transverse deformation from zero to at least fifteen degrees of the belt 105.

In embodiments, the force applied by the cylinders of the tensioning system is controlled as a function of information captured by a sensor configured to measure a value representing a state of the traction belt, for example the tension force that is applied to it. In other embodiments the force applied by the cylinders of the tensioning system is controlled as a function of information obtained by a sensor configured to measure a state of the so-called amplitude pushing means 120.

In embodiments, a spring connects the slider 136 to one end of the slideway 138. Similarly, a spring connects the slider 135 to one end of the slideway 137. In the absence of high loads on the sliders, the springs enable passive return of the sliders to their initial position.

In embodiments, an opening 139 is formed in the block 127 so as to enable the cylinder 123 to pass through the block. This embodiment is the implementation of a simplified alternative to the tensioning system, and may equally be used in combination with the tensioning system.

In this embodiment the piston of the cylinder 123 could either remain at the same height as the pistons of the cylinders 121, 122, 124, 125 or be used as a secondary tensioning system exerting a solitary thrust after the amplitude thrust. Its action will then deform the inextensible belt to provide the necessary rigidity of the inextensible belt.

The actuators 110, 121, 122, 123, 124, 125, 131 and 132 may be of any kind. For example, they may be of hydraulic, screw-nut or electric type. Pneumatic actuators may equally be used and are particularly suitable for applications requiring a low load and rapid execution.

The cylinders 110, 121, 122, 123, 124, 125, 131 and 132 may equally be replaced by any other mechanism able to exert a force on the belt 105 or one of the belts of the tensioning system and having the capacity to absorb a high return load.

In embodiments, a cylinder includes a rack, abutment or brake type locking means. For its part locking a cylinder using a fluid is inherent to stopping injection of liquid.

In embodiments, each cylinder is associated with an elastic return system including for example a spiral spring or rapid aspiration of the fluid in the case of a hydraulic cylinder.

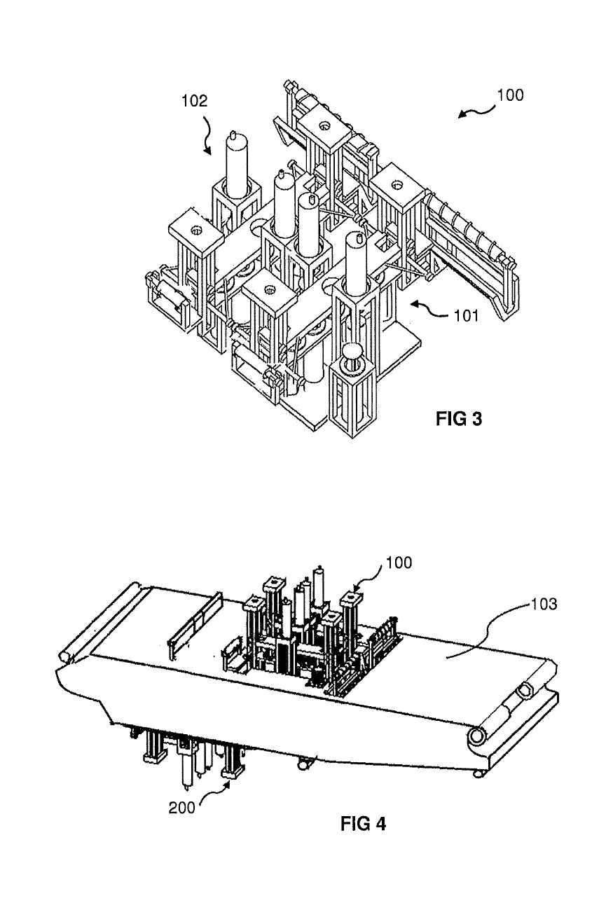

There is seen in FIG. 3 a motor-drive assembly 100 including two motor-drive devices 101 and 102 as described above.

### Description of a Second Embodiment of the Invention

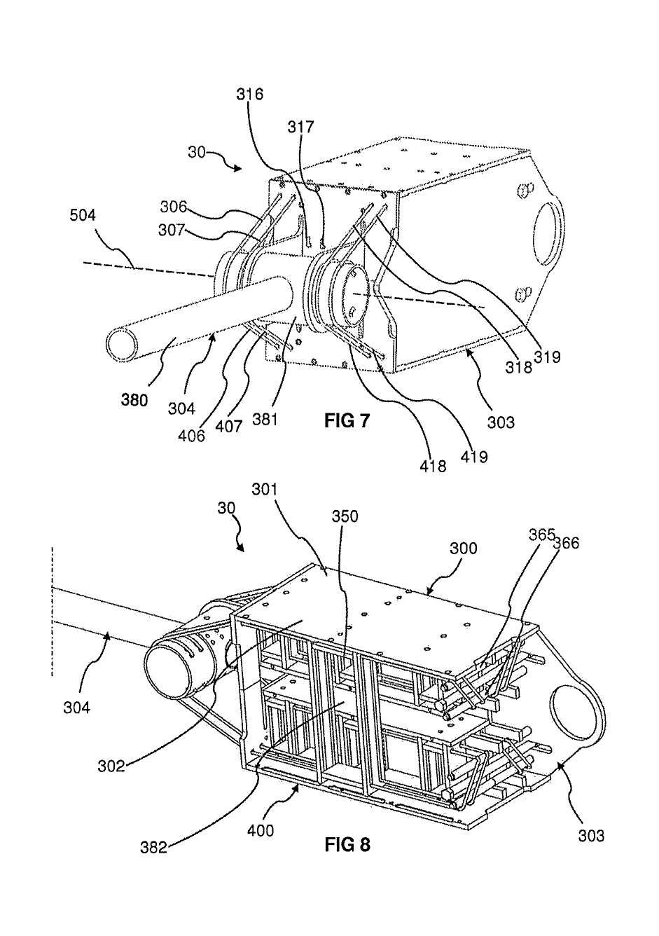

There is seen in FIGS. 7 and 8 a second embodiment of an articulated arm 30 according to the invention. The articulated arm 30 includes a first member 303 of substantially parallelepiped shape. A second member 304 is connected to the first member 303 by an articulation 381 pivoting about an axis 504. The second member 304 includes a rod 380 adapted to be mounted in a housing 382 formed in another articulated arm of the same type.

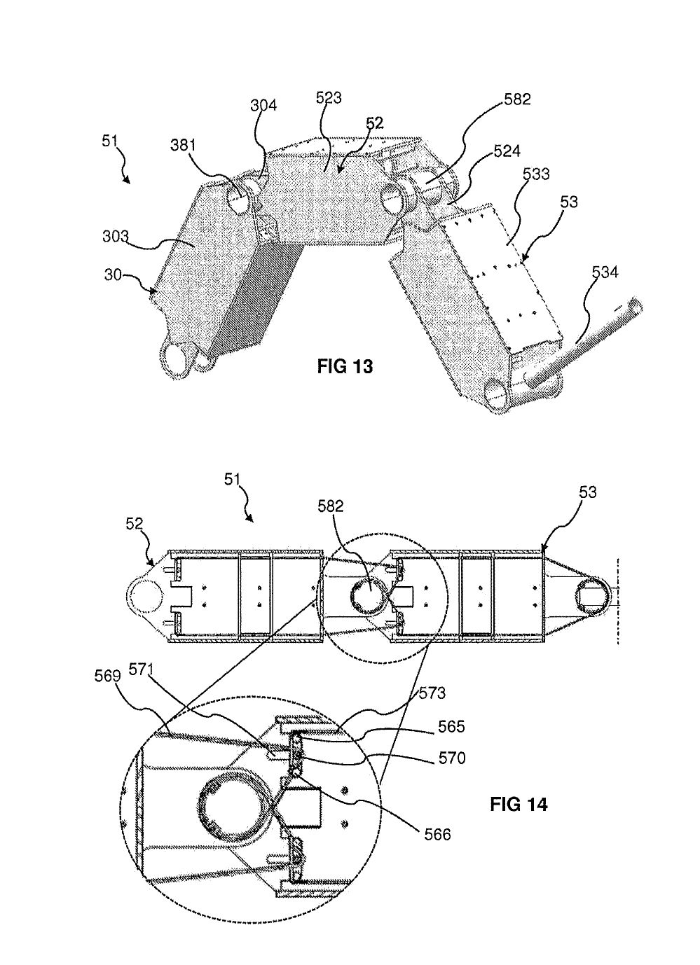

This embodiment will be easily understood in the light of FIGS. 13 and 14.

Alternatively a site tool such as for example of drill, sander, riveter, pickaxe type may be mounted on the rod 380.

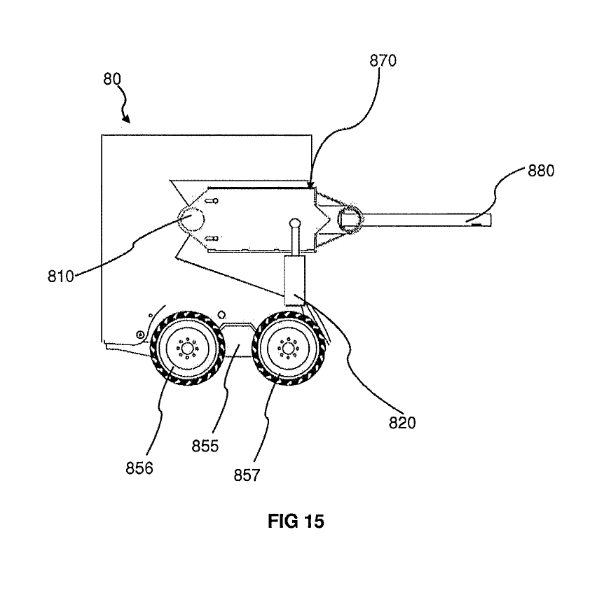

Alternatively a site machinery tool such as for example a bucket, a shovel or a hydraulic hammer may be mounted on the rod 380. This embodiment will be easily understood in the light of FIG. 15.

Two motor-drive assemblies 300 and 400 are mounted on respective opposite sides of a central plane of the first member 303. The motor-drive assemblies 300 and 400 are configured to exert a traction force that results in rotation of the second member 304 about the pivoting articulation 381. The traction force exerted by the motor-drive assembly 300 drives rotation in one direction and the traction force exerted by the motor-drive assembly 400 drives rotation in the opposite direction. A control member (not shown) is configured to control the motor-drive assemblies 300 and 400 which work in concert. A simplified version of the invention includes a single motor-drive assembly that drives rotation in one direction, rotation in the opposite direction being achieved by a spring type passive return, or simply by the action of gravity.

The two motor-drive assemblies 300 and 400 having the same technical features, because they are similar through symmetry, only the motor-drive assembly 300 is described in more detail hereinafter.

The motor-drive assembly 300 includes two motor-drive devices 301 and 302. The two motor-drive devices 301 and 302 contribute to the exertion of a traction force that results in a rotation oriented in the same direction of the second member 304 about the pivoting articulation 381.

The two motor-drive devices 301 and 302 having the same technical features, because of being similar through symmetry, only the motor-drive device 300 is described in more detail hereinafter.

The traction force exerted by the motor-drive device 301 on the pivoting articulation 381 is exerted via two parallel cables 306 and 307. The cables 306 and 307 are inextensible. A first end of each of the cables 306 and 307 is wound around the pivoting articulation 381 and fixed to the pivoting articulation 381. The other end of each of the cables 306 and 307 is fixed to respective attachment points 316 and 317 positioned on the first member 303.

It is useful to specify at this stage that the two parallel inextensible cables 306 and 307 form the belt in the sense of the invention.

The cable 306 extends from the pivoting articulation 381 in a high horizontal plane as far as a first metal bar 365 that redirects the cable 306 into a vertical inclined plane. The cable 306 continues its travel as far as a second metal bar 366 which redirects the cable 306 into a low horizontal plane. At the end of travel the cable 306 is fixed to the attachment point 316. The metal bars 365 and 366 have a very low coefficient of friction with the cables 306 and 307. The metal bars may advantageously be replaced by pulleys that fulfil the same function.

The cable 306 is routed so as to pass through a plurality of compartments including four functional compartments that host pushing means. The cable 306 passes from one compartment to another via vertical holes pierced over the height of two walls of a compartment so as to enable both horizontal movement and vertical movement.

Apart from an offset, the routing of the cable 307 being identical to the routing of the cable 306, it is not described again here.

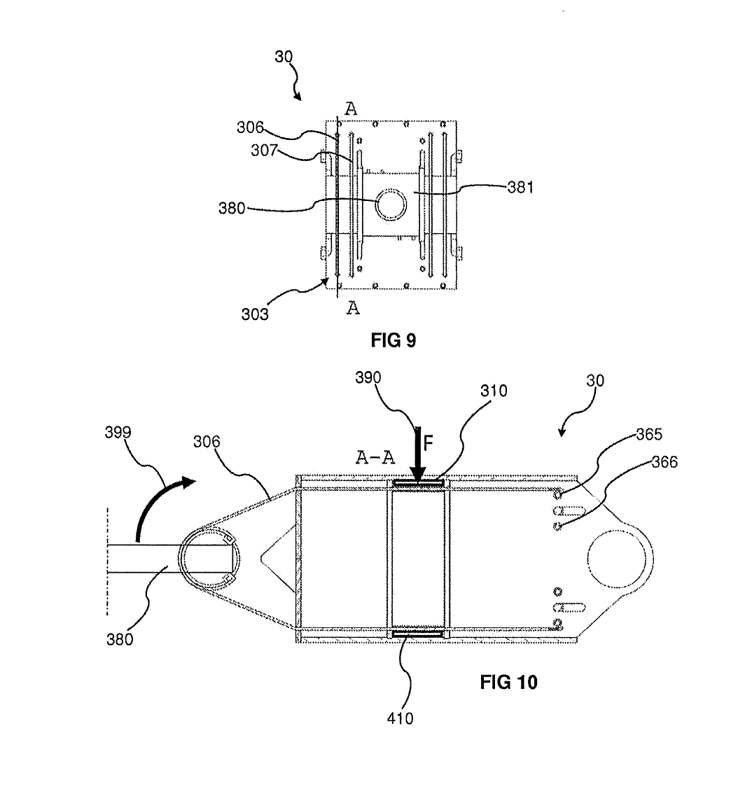

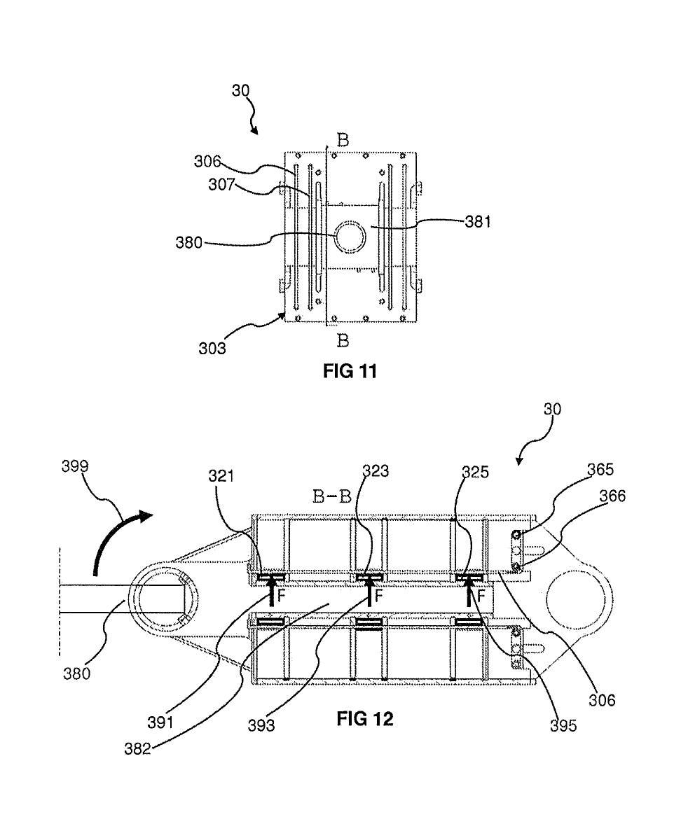

The features of the motor-drive device 301 will be understood on looking at FIGS. 9 to 12. FIG. 9 locates the line A-A that passes vertically through the motor-drive device 301. FIG. 11 locates the line B-B that passes vertically through the articulated motor-drive arm 30. The motor-drive device 301 is arranged in the upper lefthand quadrant of the articulated arm 30 shown in FIGS. 9 and 11. There is seen in FIG. 10 a section of the articulated arm 30 taken along the line A-A and there is seen in FIG. 11 a section of the articulated arm 30 in section taken along the line B-B.

The motor-drive device 301 includes pusher means configured to exert a transverse thrust on the inextensible traction cables 306: a so-called force pushing means 310 and a so-called amplitude pushing means.

The pushing means are interleaved compactly in an enclosure formed around the articulated arm in order to minimize its overall bulk.

The so-called force pushing means 310, visible in FIG. 10, includes a cylinder configured to exert a transverse thrust force 390 on a narrow portion of the cables 306 and 307. The transverse force 390 imposed by the pushing means 310 on the two cables 306 and 307 is applied in an optimum manner to enable the movement 399 in rotation of the second member 304 about the pivoting articulation 381 at the cost of a small incoming energy expenditure relating to the work of the mobilized load.

The compartment accommodating the so-called force pushing means 310 is disposed on the exterior border of the articulated arm 30. Said compartment advantageously accommodates both the so-called force pushing means 310 of the motor-drive device 301 and a so-called force pushing means 410 facing it.

A thrust plate 350 formed by a plate pierced by two through-holes through which the cables 306 and 307 pass advantageously enables transmission of the force applied by the so-called force pushing means 310 to the cables 306 and 307.

In embodiments, the thrust is produced by a hydraulic cylinder system including at least one pump, a flexible pocket contained in a rigid compartment, and at least one solenoid valve. Controlled injection of a fluid into the flexible envelope causes an increase in volume that results in a downwardly oriented transverse thrust force 390.

To ensure that the lengthwise expansion of the cylinder is controllable and can be maintained despite the high variable counter-thrust produced by the variations in tension of the pairs of parallel inextensible cables, the hydraulic cylinder includes a flexible pocket of incompressible fluid contained in a rigid compartment one wall of which is mobile in vertical translation. The mobile wall is formed by the thrust plate 350.

The hydraulic cylinder actuated by inflating a sealed pocket in a rigid compartment with a single mobile wall associated with at least one incompressible fluid inlet valve at the so-called upstream circuit end at relatively higher pressure and at least one incompressible fluid outlet valve at the end of a downstream circuit at a lower relative pressure.

The pre-valve pressurized fluid inlet enables expansion of the sealed pocket causing the free wall to rise.

The pre-valve pressurized fluid outlet enables the loss of volume of the sealed pocket in its jacket allowing the descent of the free wall.

In order to enable operation of the hydraulic system a control member (not shown) is used to command opening and closing of the injection and suction solenoid valve connected to each of the pushing means of the motor-drive devices.

The basic assembly formed by the pocket and the rigid compartment with a free wall is moreover associated with a return spring system that enables movement of the free wall up to the volume of the pocket whatever the tension in the two parallel cables 306 and 307 that pass through the thrust plate 350.

This mechanism enables deformation of the inextensible cables 306 and 307 and therefore accurate control of the amplitude gain or loss, that is to say the position of the second member 304 relative to the first member 303 unrelated to the power supply.

The so-called amplitude pushing means, visible in FIG. 12, includes three cylinders 321, 323 and 325 comprising two cylinders 321 and 325 at the limits of the extended thrust zone and a cylinder 323 at the center. The cylinders are configured to exert respective transverse thrust forces 391, 393 and 395 over a wide extent of the two cables 306 and 307.

The transverse force imposed by the so-called amplitude pushing means on the two cables 306 and 307 is applied optimally to enable the deformation of said parallel cables in order to remain under tension after pivoting of the lever arm.

Thrust plates formed by a plate pierced with two through-holes through which the cables 306 and 307 pass advantageously enable transmission of the force applied by the cylinders 321, 323 and 325 to the cables 306 and 307.

The compartments accommodating the cylinders 321, 323 and 325 of the so-called amplitude pushing means are disposed on the interior part of the articulated arm 30. Said compartments are of a height adapted to leave a central space in order to accommodate a housing 382.

In embodiments, the thrust is produced by at least one cylinder of the so-called amplitude pushing means. This thrust is produced by a hydraulic system comparable to that described hereinabove.

In embodiments, each cylinder 320, 321, 323 and 325 is associated with an elastic return system including for example a spiral spring (not shown) or rapid aspiration of fluid in the case of a hydraulic cylinder.

In this second embodiment, the tensioning system is integrated into the so-called amplitude pushing system. The cylinder 323 could either exert a force 393 similar to the forces 391 and 395 exerted by the cylinders 321 and 323 or be used as a tensioning system exerting an additional solitary thrust after the amplitude pushing. This action will deform the inextensible cables to produce increased stiffness of the cables 306 and 307. The tensioning system enables tensioning of the two traction cables 306 and 307 without oversizing and/or complicating the so-called amplitude pushing means.

Each cylinder advantageously includes a locking means that may consist in a rack, an abutment, a brake, a valve or preferably a column of incompressible water controlled by a solenoid valve.

There is seen in FIG. 13 a multi-articulated arm 51 including a plurality of articulated arms 30, 52, 53 mounted in series. The multi-articulated arm 51 may also be designated a poly-articulated arm.

The features of the articulated arm 30 being those described above, they are not repeated in detail here. The features of the articulated arms 52 and 53 are similar to the features of the articulated arm 30.

Each of the articulated arms 30, 52, 53 includes a first member 303, 523, 533 and a second member 304, 524, 534. The first member 303 of the articulated arm 30 is articulated to the second member 304 by a pivoting articulation 381. The second member 304 includes a rod adapted to be inserted in, mounted in and fixed to a housing provided for this purpose in the articulated arm 523. In other words, the second member 304 of the articulated arm 30 is fixed to the first member 523 of the articulated arm 52 so as to form an assembly that constitutes one link of the multiarticulated arm 51.

Similarly, the first member 523 of the articulated arm 52 is articulated to the second member 524 by a pivoting articulation 582. The second member 524 includes a rod adapted to be inserted in and fixed in a housing provided in the first member 533 of the articulated arm 523.

There is seen in FIG. 14 the multi-articulated arm 51 at the level of the articulation 582 between the two articulated arms 52 and 53.

In the embodiment shown in FIG. 14 the articulated arms 52 and 52 are connected in series, the inextensible traction belts of the motor-drive devices of the articulated arm 52 being fastened to the inextensible traction belts of the motor-drive devices of the articulated arm 53 by a common point of contact. Said common point of contact is for example a bar 570 positioned in a horizontal slideway 571. The bar 570 forms a point of contact, crossing of two sets of traction belts of two successive articulated arms.

The belt 569 of one of the motor-drive devices of the articulated arm 52 is wound around the pivoting articulation 582 and then passed around the bar 570 so that a traction force exerted by said motor-drive device on the belt 569 exerts a force on the bar 570 the movement of which is constrained by the shape of the slideway 571.

The routing of the belt 573 from one of the motor-drive devices of the articulation arm 53 is constrained by the metal bars 565 and 566 that are disposed on respective opposite sides of the bar 570. A force exerted on the belt 569 by the motor-drive device of the articulated arm 52 is therefore applied to the bar 570, and that force is in turn transmitted to the belt 573 of the motor-drive device of the articulated arm 53.

The routing of the belt 570 is similar to that described for the articulated arm shown in FIGS. 7 to 12, and is therefore not repeated in detail here.

These features may be adapted to a multi-articulated arm in which each articulated arm carries two motor-drive assemblies each including two motor-drive devices each connected to its counterpart of the articulated arm that follows on from it. This connection is identical, directly or through symmetry, for each belt.

This assembly by interleaved contact bearing between the belts of two successive motor-drive devices enables additive combination of the powers supplied by each motor-drive device chained in this way.

### Description of One Example of the Functioning of the Invention

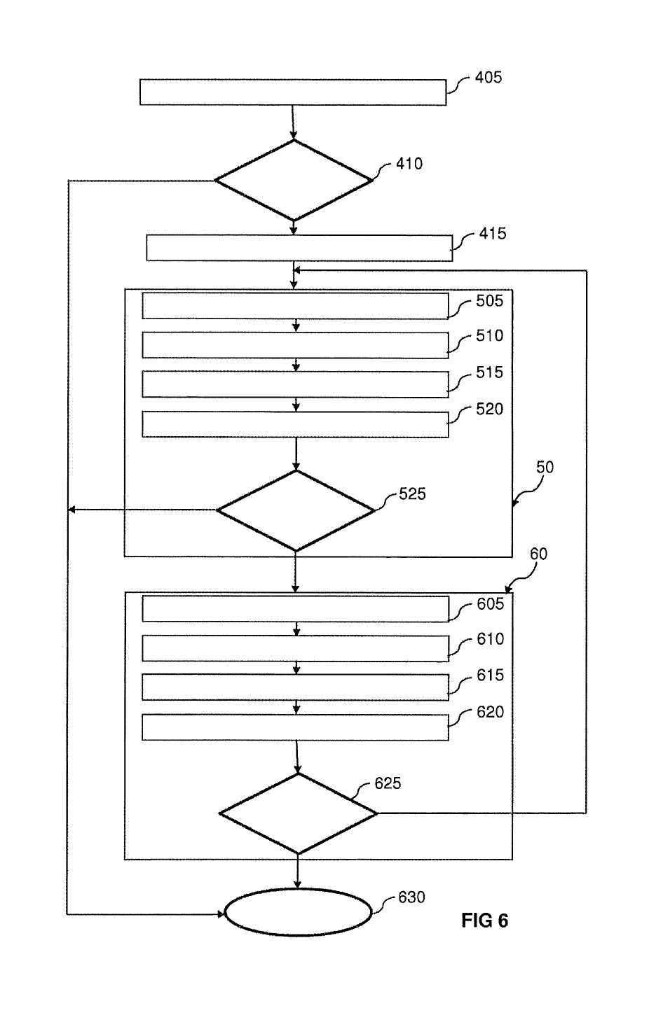

There is seen in FIG. 6 a flowchart illustrating one example of a method 40 for lifting a load by means of an articulated arm that includes a first member articulated to a second member. Lifting is performed by a motor-drive assembly controlled by a control member and including a first motor-drive device and a second motor-drive device. The lifting method 40 includes the following steps:
traction 50 on a first inextensible traction belt connecting an attachment point on the first member to an attachment point on the second member,
traction 60 on a second inextensible traction belt connecting an attachment point on the first member to an attachment point on the second member.

At least one of the traction steps 50, 60 employing a transverse thrust on a traction belt and the traction steps 50, 60 is repeated until the second member is raised to a required height.

In embodiments, the method of lifting a load by means of an articulated arm according to the invention further includes a step in which a tensioning system bearing on a pushing means tensions the traction belt.

In embodiments, at least one traction step 50, 60 includes, in sequence, the following steps:
releasing 505, 605 the tension exerted on the inextensible traction belt by a so-called force pushing means and releasing 510, 610 the tension exerted by the tensioning system,
tensioning 515, 615 the inextensible traction belt by transverse thrust by a so-called amplitude pushing means,
tensioning 520, 620 the inextensible traction belt bearing on a pushing means by a tensioning system,
tensioning 525, 625 the inextensible traction belt by transverse thrust from a so-called force pushing means, and
monitoring 530, 630 the lifting of the second member.

In embodiments, the method of lifting a load by means of an articulated arm according to the invention further includes a preliminary step including the following steps:
tensioning 405 by the so-called amplitude pushing means of the first motor-drive device and the second motor-drive device,
monitoring 410 the lifting of the second member, and
tensioning 415 the inextensible traction belt of the second motor-drive device by a transverse thrust from a so-called force pushing means.

In order better to explain the lifting method that constitutes the subject matter of the invention there is described hereinafter a method for lifting a load using an articulated arm 30 as shown in FIGS. 7 to 12.

Remember that the articulated arm 30 includes a first member 303 articulated to a second member by a motor-drive assembly 300 controlled by a control member (not shown) and including a first motor-drive device 301 and a second motor-drive device 302.

According to the method that is the subject of the invention, a first motor-drive device 301 linked to a first pair of parallel inextensible traction cables 306 and 307 and a second motor-drive device connected to a second pair of parallel inextensible traction cables 318 and 319 cooperate to exert a common traction force with the aim of causing movement of the rod 380 of the second member 304 about the axis 504. The two motor-drive devices 301 and 302 function in sequence. The amplitude of deployment of an articulated arm is considered in the example hereinafter.

If a state of the motor-drive assembly is considered in which the pairs of parallel traction cables of a first motor-drive device and a second motor-drive device are under tension:
the application of a primary transverse thrust force to the two parallel cables 306 and 307 by the so-called force pushing means of the first motor-drive device 301 enables an amplitude gain and thus the expansion of the two parallel cables 318 and 319,
the tension on the second pair of two parallel cables 318 and 319 is taken up by the application of a transverse thrust force by the two end cylinders of the so-called amplitude pushing means of the second motor-drive device 302.

The tensions in the two cables 318 and 319 of the second motor-drive device 302 are balanced by deformation thereof by the resulting supplemental rise through at least the pressure equilibrium of the central cylinder of the so-called amplitude pushing means that here serves as a tensioning system.

Once amplitude and force equilibrium have been achieved, the position is imposed by the two systems interchangeably.

Thereafter, starting up the so-called force pushing means of the second motor-drive device 302 could produce a traction force causing the expansion of the two parallel inextensible cables of the first motor-drive device 301 and therefore enable reinitialization of the so-called force pushing means and of the tensioning system.

Still with reference to the articulated arm 30 as shown in FIGS. 7 to 12, it is clear that in addition to the first motor-drive assembly 300 the articulated arm includes a second motor-drive assembly 400. The second motor-drive assembly enables application of a transverse force to the cables 406, 407, 418 and 419 so as to exert a tension on these cables and to cause the rod 380 of the second member 304 to move about the axis 504 in the opposite direction to the movement driven by the assembly 300.

The motor-drive assemblies 300 and 400 cooperate to exert an opposite tension force torque with the aim of mobilizing over at least 160 degrees a lever arm accurately and independently of the variation of the load exerted on the lever arm.

Considering a state of the motor-drive assembly 300 in which the two parallel traction cables 306, 307 and 318, 319 of the motor-drive devices 301 and 302 are under tension:
the amplitude gain by the motor-drive assembly 300 transversely pushing on the pairs of parallel cables in accordance with the sequences already described above and an equivalent amplitude loss by releasing the transverse thrust on the pairs of parallel cables by the opposite motor-drive assembly 400 in accordance with the sequences that are the converse of those described above enables a change of position of the rod 380 of the second member 304 whilst preserving the stiffness of the second member relative to the first member.

In other words, the two motor-drive assemblies 300 and 400 cooperate to mobilize the second member 304 relative to the first member 303 whilst maintaining a relative stiffness between the two members at all times.

### Variant Embodiments of the Invention

In embodiments, the belt 105 includes an elastic strip (not shown) attached at two points along its length so that when at rest the belt is accordion-folded on itself. On the other hand, when the belt is under tension, the elastic strip is stretched without impeding the function of the inextensible belt.

When the belt 105 is relaxed the elastic strip enables folding of the inextensible belt so as to prevent the latter from relaxing in the motor-drive mechanism, and also enables retention of sufficient stiffness in the lever arm thanks to the elastic stiffness configured under no load.

There is seen in FIG. 4 an embodiment in which the articulated arm 10 includes a supplementary motor-drive assembly 200 mounted in a mirror image of the motor-drive assembly 100 on the member 103 so as to drive the pivoting of the second member about the axis 500 in both rotation directions.

In embodiments, three motor-drive assemblies 100 are disposed in a triangle all around the first member. This embodiment allows pivoting of the second member in all directions. In this embodiment a ball-joint connection allowing three degrees of freedom in rotation connects the first and second members.

In embodiments, six motor-drive assemblies 100 are disposed in a hexagon all around the first member. This embodiment enables pivoting of the second member in all directions with finer control than in the previous embodiment. In this embodiment a ball-joint connection allowing three degrees of freedom in rotation connects the first and second members.

In embodiments, a plurality of motor-drive devices are connected in series, the traction belt of each motor-drive device being fastened to the traction belt of the next motor-drive device by a common point of contact. To be more precise, referring to FIG. 5, two motor-drive assemblies may be interconnected. The downstream motor-drive assembly then has its posterior pulley mounted on a pivot arm at the end point of the belt of the upstream motor-drive assembly. The belt of the upstream system may be fixed to the pivot arm 171 in a similar manner to the fixing of the belt 105 to the attachment points 108 and 109. The pivot arm 171 may be retracted by the upstream motor-drive assembly and therefore tension the belt of the downstream motor-drive assembly. With no action from the upstream motor-drive assembly, the pivot is maintained in oblique abutment on the downstream side by a spiral spring (not shown).

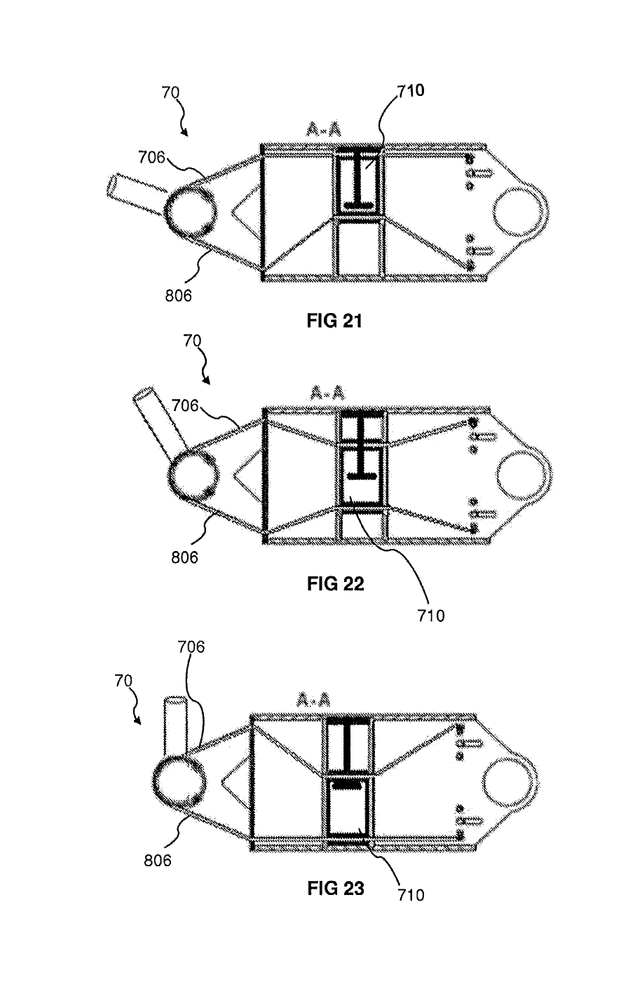

In embodiments represented in FIGS. 21 to 25, at least one pushing means of the articulated arm according to the invention is common to two antagonistic motor-drive assemblies. To this end, the traction belts of two motor-drive devices belonging to two antagonistic motor-drive assemblies come to bear on respective opposite sides on said pushing means so that the movement of the piston of said pushing means leads to simultaneous action on said two belts. Said pushing means drives transverse deformation of one of the two belts that results in an increased tension in said belt and said pushing means simultaneously reduces the transverse deformation of the other belts, resulting in a reduced tension in said other belts.

This embodiment has the advantage of reducing the number of pushing means that need to be used for the functioning of an articulated arm according to the invention including two motor-drive assemblies.

This mode of use with pushing means common to two antagonistic motor-drive assemblies may concern the so-called force pushing means just as much as the so-called amplitude pushing means.

By way of example, there is seen in FIGS. 21 to 25 a particular use of the articulated arm according to the invention in which the pushing means 710, 721 and 725 are common to two antagonistic motor-drive assemblies.

The general structure and most of the features described above for the articulated arm 30 are repeated in the articulated arm 70.

FIGS. 21, 22 and 23 show in section taken along a line A-A, by analogy with the section taken along the line A-A in FIGS. 9 and 10, different positions of the so-called force pushing means 710. The pushing means 710 is fixed on respective opposite sides to the belts 706 and 806. The thrust exerted by the pushing means 710 drives the deformation of the belt 706 by transverse traction and simultaneously drives the relaxation of the upper belt 806, or vice versa. In FIG. 21 the pushing means 710 is shown in a high position and exerts an upwardly oriented thrust on the belt 806 that results in tensioning of said belt and does not exert any tension on the belt 706. The converse situation is shown in FIG. 23, and an intermediate situation is shown in FIG. 22.

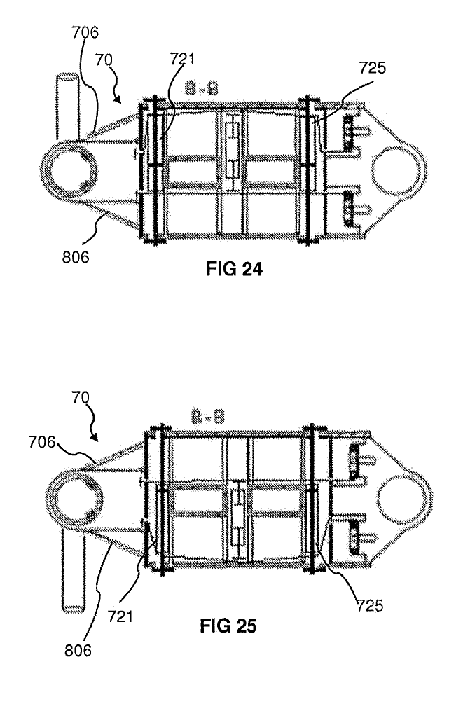

FIGS. 24 and 25 show in section taken along a line B-B, by analogy with the section taken along the line B-B in FIGS. 11 and 12, different positions of the so-called amplitude pushing means 721 and 725. Here the so-called amplitude pushing means 721 and 725 are through-cylinders including a central portion capable of exerting an upward or downward thrust force. The so-called amplitude pushing means 721 and 725 function in concert. The traction belts 706 and 806 of two motor-drive devices belonging to two antagonistic motor-drive assemblies come to bear on respective opposite sides of the central portions of the so-called amplitude pushing means 721 and 725.

In embodiments, the so-called amplitude pushing means 721 and 725 are interconnected by a rigid horizontal bar that fastens them together mechanically.

In FIG. 24 the pushing means 721 and 725 are in a high position and exert an upwardly oriented transverse thrust force on the traction belt 706 at the same time as releasing the transverse thrust force exerted on the traction belt 806.

In FIG. 25 the pushing means 721 and 725 are in a low position and exert a downwardly oriented transverse thrust force on the traction belt 806 at the same time as releasing the transverse thrust force exerted on the traction belt 706.

### Description of One Particular Embodiment of Site Machinery Carrying an Articulated Arm According to the Invention

There is seen in FIG. 15 a site machine 80 carrying an articulated arm according to the invention. The site machine 80 carries and enables the actuation of heavy tools that are difficult to manipulate for a builder or any other worker liable to manipulate this kind of tool. The tool is fixed to the rod 880 of an articulated arm 870.

The features of the articulated arm 870 being similar to the features of the articulated arm shown in FIGS. 7 to 12, they are not repeated here.

By way of example, the site machine 80 enables the use of a concrete circular saw type tool, power chisel/perforator type tool or sanding and scraping type tool.

The site machine 80 rests on a platform 855 mobile by means of wheels 856, 857 or caterpillar tracks. The operation of the site machine 80 may be automated or controlled externally, by wire or remotely.

The articulated arm 870 is fixed to the site machine 80 at its proximal end by a pivot connection or ball-joint connection type connection 810. Also, the articulated arm 870 rests on two vertical pistons 820 with ball-joint type lateral connection points acting independently.

This embodiment moreover enables relative movement through 180 degrees of the articulated arm 870, positive and negative relative movement about the horizontal axis, and clockwise and anticlockwise rotation.

The tool therefore has the benefit of a vertical relative movement of more than 180 degrees with right or left inclination in addition to plane rotation and/or reverse movements.

The site machine 80 enables intervention with the tool from an elevation above ground level up to an elevation of 3.5 meters.

In embodiments, the site machine 80 further includes an aspiration means (not shown) passing through the articulated arm 870 as far as the end of the rod 880 enabling aspiration of debris produced by the action of the tools carried. The aspiration means may consist in a suction device and a storage sack that may form an integral part of the machine.

In embodiments, the site machine 80 further includes a water supply circuit (not shown) configured to reproduce the tool.

In embodiments, the site machine 80 further includes a water supply circuit (not shown) and a water recovery circuit adapted to spray the working area continuously in order to evacuate the debris.

The features of the articulated arm according to the invention enable geometrical deformation with no connection with the resistance encountered, and it is therefore possible to program accurately the movement in three dimensions of the tool carried.

The site machine 80 may further include an anti-overturning system including two pistons or four pistons positioned at least at the rear and/or front corners of the platform 855 for ensuring stability of the machine 80 during use of the tools.

The lever arm may consist of two or more sliding sleeves forming a telescopic rod for modifying the length of the arm as a function of the required length.

### Description of a Second Particular Embodiment of a Site Machine Carrying an Articulated Arm According to the Invention

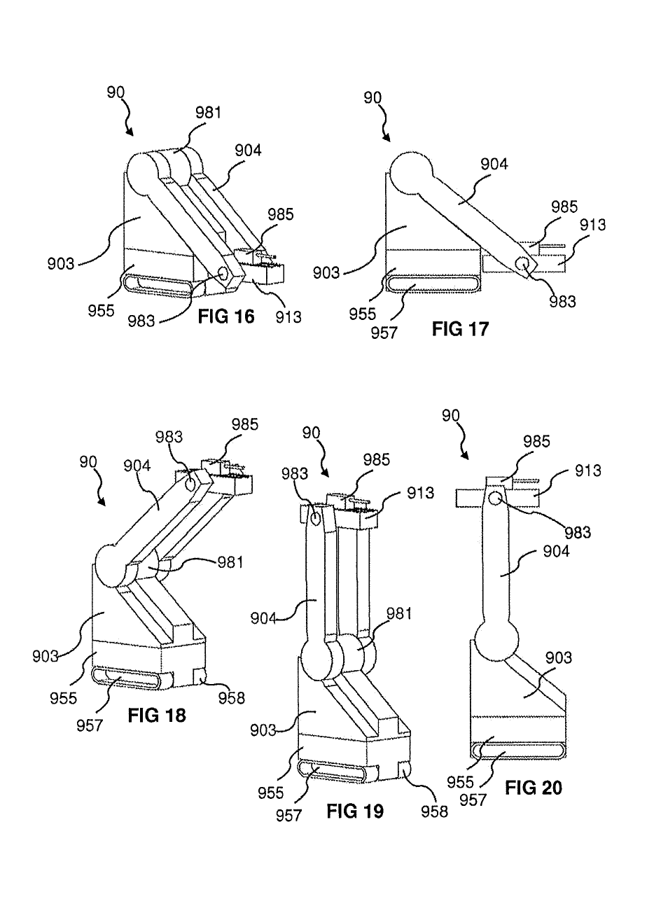

There are seen in FIGS. 16 to 20 various views of a site machine 90 including a multi-articulated arm. The multi-articulated arm includes two articulations. The first articulation is a pivot connection 981 between the first member 903 and the second member 904. The second articulation is a pivot connection 983 between the second member 904 and the third member 913.

The third member carries a tool 985, also termed an effector. The effector is a tool of concrete circular saw type, power chisel/perforator type or sanding and scraping type, for example.

The movement of the second member 904 around the pivot connection 981 is motorized by two motor-drive assemblies accommodated in the first member 903. Said motor-drive assemblies being similar to those described above, they are not described again here.

The movement of the third member 913 about the pivot connection 983 is driven by two motor-drive assemblies accommodated in the second member 904. Said motor-drive assemblies being similar to those described above, they are not described again here.

The site machine 90 rests on a platform 955 mobile by means of caterpillar tracks 957, 858. The operation of the site machine 90 may be automated or controlled externally, by wire or remotely. The site machine 90 is preferably a remote-controlled or autonomous machine.

1. An articulated arm (10, 30) including a first member connected by an articulation pivoting about an axis (500) to a second member, characterized in that it is motorized by a motor-drive assembly (100) including:
at least one first motor-drive device (101) and one second motor-drive device (102),
at least one inexpensible traction belt (105) connecting the first and the members,
each motor-drive device including at least two pushing means (110, 120) configured to exert a transverse thrust on the traction belt, and
a control member adapted to cause the pushing means to function in a sequence including at least the application of a transverse thrust force to the traction belt (105) causing deformation of and an increase in the tension in said belt, carried by the first motor-drive device (101), and at least the application of a transverse thrust force causing deformation of and an increase in the tension in the inextensible belt carried by the second motor-drive device (102), the successive deformations and increases in tension enabling pivoting of the second member (104) about the axis (500) of the articulation.

2. The articulated arm (10, 30) as claimed in the preceding claim, in which at least one motor-drive device (101, 102, 301, 302) employs a so-called force pushing means (110, 310) that includes a cylinder configured to exert a transverse force on a narrow portion of the traction belt (105, 306, 307), said belt being arranged so that the angle between the traction belt at rest and the traction belt moved by the so-called force pushing means is able to vary from zero to at least fifteen degrees.

3. The articulated arm (10, 30) as claimed in claim 1, in which at least one motor-drive device (101, 102, 301, 302) employs a so-called amplitude pushing means (120, 320) that includes a plurality of cylinders (121, 122, 123, 124, 125, 321, 323, 325) configured to exert a transverse thrust over a larger extent of the traction belt (105, 306, 307).

4. The articulated arm (10, 30) as claimed in claim 1, in which the attachment point (108) of the second member is positioned at a distance from the articulation less than twenty percent of the length of the second member.

5. The articulated arm (10, 30) as claimed in claim 1, in which at least one motor-drive device (101, 102, 301, 302) includes a tensioner system configured to tension the traction belt (105, 306, 307) by bearing on a pushing means.

6. The articulated arm (10) as claimed in the preceding claim, in which the tensioning system includes a belt (135) adapted to exert a force on the traction belt (105) via two sliding attachments (135, 136).

7. The articulated arm (10, 30) as claimed in claim 1, in which at least one motor-drive device (101, 102, 301, 302) includes at least one pulley (160) or at least one metal bar (365, 366) arranged so as to bend the traction belt (105, 306, 307) on itself in a “U” shape over a portion of its length.

8. The articulated arm (10, 30) as claimed in claim 1, in which the transverse thrust exerted by the at least one of the pushing means is exerted by one or more hydraulic cylinders.

9. The articulated arm (10, 30) as claimed in the preceding claim, in which at least one cylinder includes locking means of rack, abutment, brake, clapet or vanne type.

10. The articulated arm (10, 30) as claimed in claim 1, including a supplementary motor-drive assembly enabling pivoting of the second member about the axis (500) of the pivoting articulation in the opposite rotation direction.

11. The articulated arm (10, 30) as claimed in claim 1, in which the first member and the second member are articulated by a ball-joint connection and including at least three motor-drive assemblies (100) disposed in a triangle all around the first member, enabling pivoting of the second member in all directions.

12. The multi-articulated arm (51) as claimed in claim 1, including a plurality of articulated arms (30, 52, 53) as claimed in any one of the preceding claims, said articulated arms being interconnected in series.

13. The multi-articulated arm (51) according to the preceding claim, in which the inextensible traction belt of at least one motor-drive device is fastened to the inextensible traction belt of the motor-drive device of the next articulated arm by a common point of contact.

14. A method (40) of lifting a load by means of an articulated arm including a first member articulated to a second member and by a motor-drive assembly (100) controlled by a control member and including a first motor-drive device and a second motor-drive device, characterized in that it includes the following steps:
traction (50) on a first inextensible traction belt connecting an attachment point on the first member to an attachment point on the second member,
traction (60) on a second inextensible traction belt connecting an attachment point on the first member to an attachment point on the second member,
at least one of the traction steps employing a transverse thrust on a traction belt and the traction steps (50, 60) being repeated until the second member is raised to a required height.

15. The method (40) as claimed in claim 13 of lifting a load by means of an articulated arm, further including tensioning by a tensioning system of the inextensible traction belt bearing on a pushing means.

16. The method (40) as claimed in claim 13 of lifting a load by means of an articulated arm in which at least one traction step (50, 60) includes, in sequence, the following steps:
releasing (505, 605) the tension exerted on the inextensible traction belt by a so-called force pushing means and releasing (510, 610) the tension exerted by the tensioning system,
tensioning (515, 615) the inextensible traction belt by transverse thrust from a so-called amplitude pushing means,
tensioning (520, 620) the inextensible traction belt bearing on a pushing means by a tensioning system,
tensioning (525, 625) the inextensible traction belt by transverse thrust from a so-called force pushing means, and
monitoring (530, 630) the lifting of the second member.

17. The method (40) as claimed in claim 13 of lifting a load, further including a preliminary step including the following steps:
tensioning (405) by the so-called amplitude pushing means of the first motor-drive device and the second motor-drive device,
monitoring (410) the lifting of the second member, and
tensioning (415) the inextensible traction belt of the second motor-drive device by transverse thrust from a so-called force pushing means.

18. Mobile site machinery (80, 90) characterized in that it includes an articulated arm (870) according to the invention.
